(19) United States
(12) Patent Application Publication
(10) Pub. No.: US 2009/0326747 A1
(43) Pub. Date: Dec. 31, 2009

(54) Method And System For The Activation Of A Freewheeling Axle In Order To Maintain A Braking Force

(75) Inventors: Wolfram Klein, Neubiberg (DE); Oliver Mackel, Heimstetten (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/438,874

(22) PCT Filed: Jul. 11, 2007
(86) PCT No.: PCT/EP07/57120

§ 371 Date: Feb. 25, 2009

(30) Foreign Application Priority Data
Aug. 25, 2006 (DE) 10 2006 039 883.1

(51) Int. Cl. B60T 8/17

(52) U.S. Cl. 701/20

(57) ABSTRACT

In a brake system for a train, which has a plurality of axles, at least one freewheeling axle is activated for determining the position of the train and the remaining axles are activated as non-freewheeling axles for braking the train. In the event of failure of a brake which is provided on a non-freewheeling axle, a previously freewheeling axle is activated as a non-freewheeling axle and the non-freewheeling axle which has a failed brake is activated as a freewheeling axle for determining the position of the train.

The invention relates to a method and a system for activating a freewheeling axle of a train in a braking force maintaining manner, particularly in driverless train systems or more specifically AGT systems (Automated Guided Trains).

So-called AGT systems, i.e. driverless train systems, are being increasingly used in public suburban transportation and also in regional rail transit. Such trains are involved in frequent braking, particularly at stations at which the train must come to stand at a predefined position. As AGT systems carry people and, in addition, have no driver at least in some cases, the braking system in such trains must meet particular safety-critical requirements.

To detect its position, the train has a so-called freewheeling axle. This axle is neither retarded nor accelerated, so that no slipping occurs between an axle-mounted wheel and the rail on which the train is traveling. To determine the train's position, revolutions of the freewheeling axle are counted starting from a reference point.

The braking system of the train must generate sufficient braking force both during normal operation and in an emergency situation.

The necessary braking force which a train's braking system must deliver depends not only on the available braking distance but also on the train speed, the weight of the train, the friction between the train wheels and the track or more specifically the rail, and on the number of braked axles of the train.

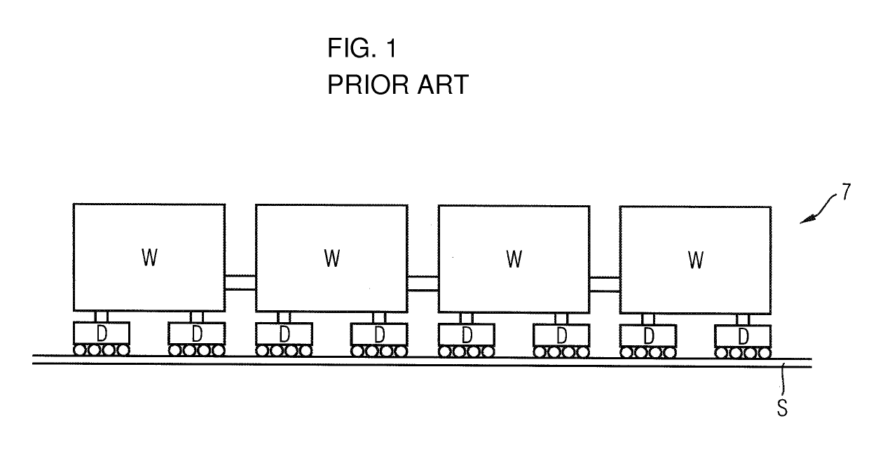

FIG. 1 shows a train Z according to the prior art which is traveling on a rail S. The train Z comprises a plurality of cars W which are coupled together, each having at least two wheel trucks D. The wheel trucks D are fitted e.g. with four axles having two wheels each. In addition to the brakes on the axles, additional braking can be achieved by the motor of the train Z. As a supplementary braking system for emergencies it is possible to additionally provide an electromagnetic rail brake in the train. However, the disadvantage of an electromagnetic rail brake is that it is relatively heavy and therefore increases the total weight of the train, or rather reduces the maximum number of passengers that can be carried. The more braked axles the train Z has, the higher the potential braking force of the train. For determining its position, the train Z requires at least one freewheeling axle. In conventional trains, the freewheeling axles have no brakes, the freewheeling axles being specified in the design and unavailable for braking.

It has therefore been proposed to determine the position of the train not via freewheeling axles but to provide a trainborne radar-based position detection system. However, providing a radar-based position detection system involves considerable additional technical complexity and in some cases fails to meet the safety criteria for a driverless train system.

In conventional train braking systems, a sufficient number of braked axles are therefore provided in order to deliver the necessary braking force even in a situation with particularly adverse conditions. The necessary number of braked axles N is designed for minimum friction μ between the wheels and the rail S at simultaneously high speed V of the train Z and high weight G of the load carried.

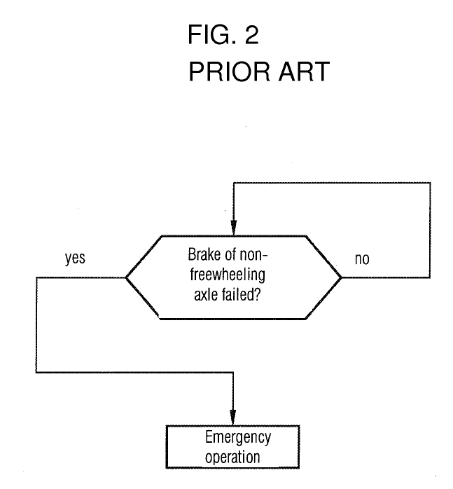

In a conventional braking system for a train Z, continuous monitoring is customarily performed to ascertain whether or not one of the brakes on a non-freewheeling axle of the train Z has failed, as illustrated in FIG. 2. If this is the case, the train Z goes into emergency mode whereby the speed V of the train is reduced and the train indicates that it requires a repair as soon as possible. On the basis of the conventional procedure shown in FIG. 2, failure of the train Z and timetable disruption are relatively frequent occurrences.

The object of the present invention is therefore to create a method and a system for braking a train which reliably provides the required braking force while minimizing the number of train failures.

This object is achieved according to the invention by a method having the features set forth in claim 1.

The invention creates a method for activating a freewheeling axle of a train Z having a plurality of axles in a braking force maintaining manner,

wherein at least one freewheeling axle F is activated to determine the position of the train and the remaining axles N are activated as non-freewheeling axles for braking the train Z,
wherein in the event of failure of a brake provided on a non-freewheeling axle N, a hitherto freewheeling axle F is activated as a non-freewheeling axle N and the non-freewheeling axle N having the failed brake is activated as a freewheeling axle F for determining the position of the train Z.

In a preferred embodiment of the method according to the invention, if brake failure occurs, an axle hitherto activated as freewheeling is only activated as non-freewheeling when it is established that the brakes provided on the freewheeling axle have not failed.

In another embodiment of the method according to the invention, emergency operation of the train is initiated if it is ascertained that no freewheeling axle whose brakes have not failed is now available.

In a further embodiment of the method according to the invention, the axles are initialized as non-freewheeling for braking the train and as freewheeling axles for determining the position of the train.

In a preferred embodiment of the method according to the invention, for normal braking the train is braked by applying the brakes of the axles activated as non-freewheeling.

In a preferred embodiment of the method according to the invention, for emergency braking the train is braked both by applying the brakes of the axles activated as non-freewheeling and by brakes additionally fitted to the axles activated as freewheeling.

In another embodiment of the method according to the invention, if a brake of a non-freewheeling axle mounted to a first wheel truck has failed, and the first wheel truck no longer has a freewheeling axle, a second wheel truck which does have a freewheeling axle is searched for, said freewheeling axle being activated as a freewheeling axle and a non-freewheeling axle of the first wheel truck being activated as a freewheeling axle.

The invention also creates a braking system for a train having a plurality of axles,

wherein at least one freewheeling axle F is activated for determining the position of the train Z and the remaining axles are activated as non-freewheeling axles N for braking the train Z,
wherein in the event of failure of a brake provided on a non-freewheeling axle N, a hitherto freewheeling axle F is activated as a non-freewheeling axle N and the non-freewheeling axle N having a failed brake is activated as a freewheeling axle F for determining the position of the train Z.

In a preferred embodiment of the braking system according to the invention, two wheels are mounted to each axle, each wheel having a brake for braking the train.

In a preferred embodiment of the braking system according to the invention, a brake controller is provided which controls the axle-mounted brakes via control lines.

In a preferred embodiment of the braking system according to the invention, the axle-mounted brakes indicate their operating state to the brake controller via indication lines.

In another embodiment of the braking system according to the invention, a sensor for detecting a rolling state of a wheel is provided on each wheel.

In another embodiment of the braking system according to the invention, the brake controller has an interface via which all the axles can each be initialized as non-freewheeling axles or as freewheeling axles.

To explain the features essential to the invention, preferred embodiments of the method according to the invention and of the braking system according to the invention will now be described with reference to the accompanying drawings in which:

FIG. 1: shows a train according to the prior art;

FIG. 2: shows a flowchart of prior art brake monitoring;

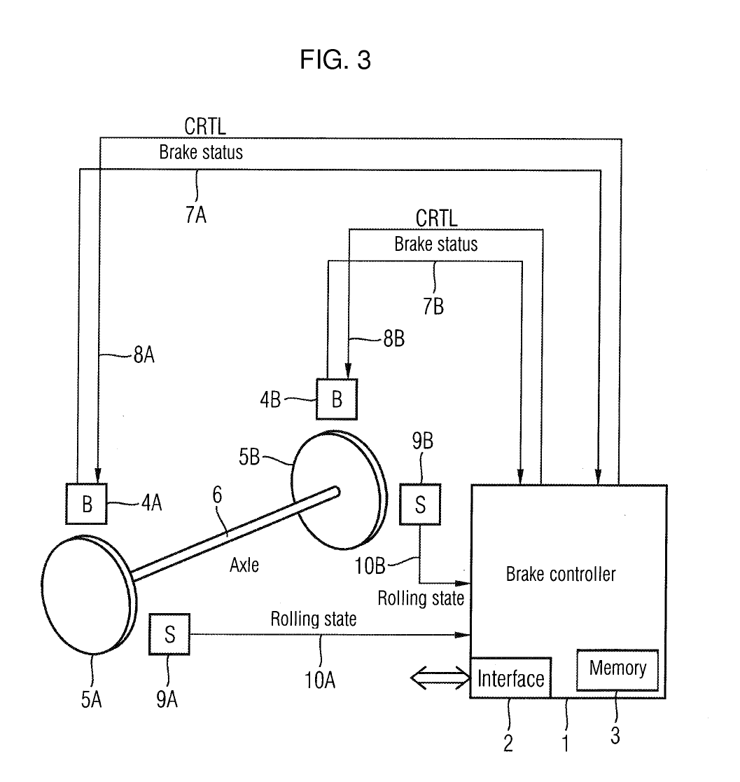

FIG. 3: shows a block diagram of a possible embodiment of the braking system according to the invention;

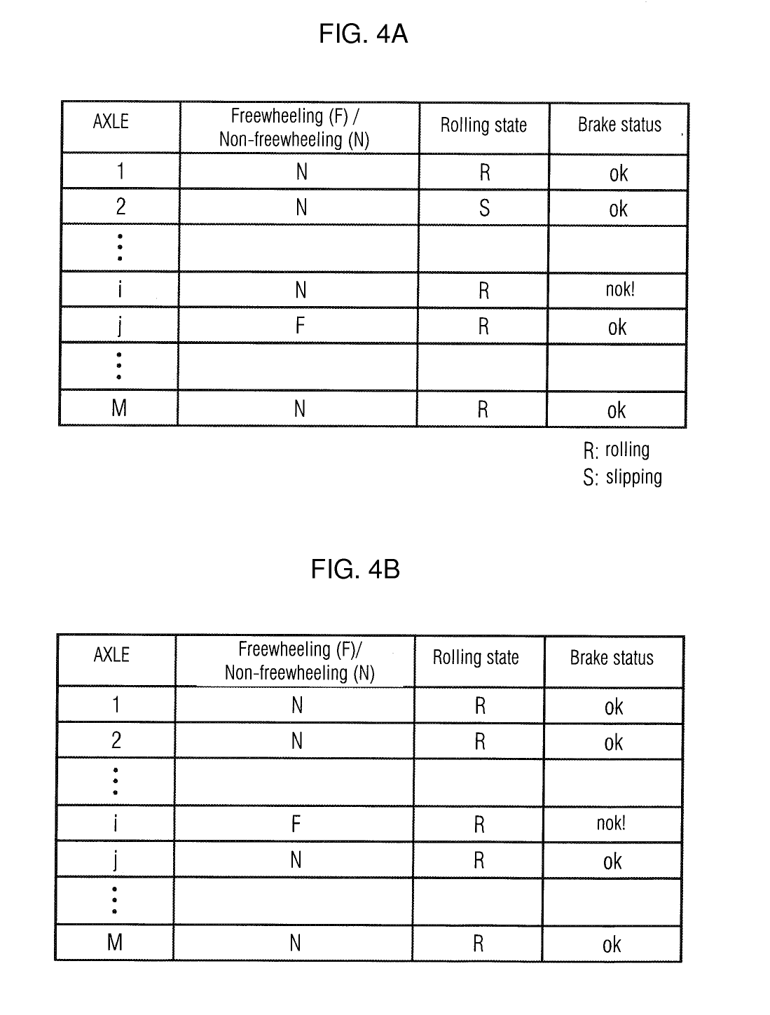

FIGS. 4A, 4B: show tables for explaining the mode of operation of the method according to the invention;

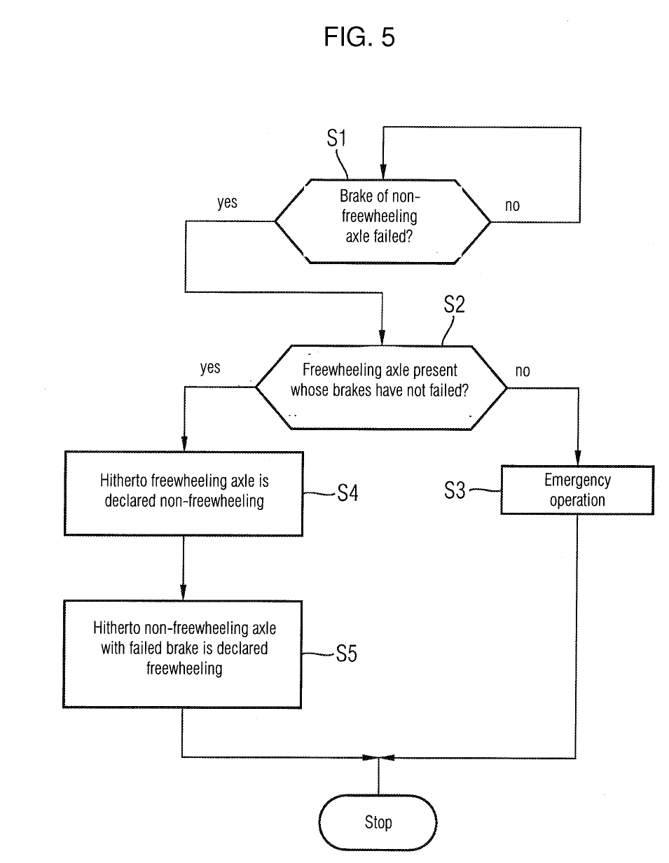

FIG. 5: shows a flowchart of brake monitoring for the braking system according to the invention;

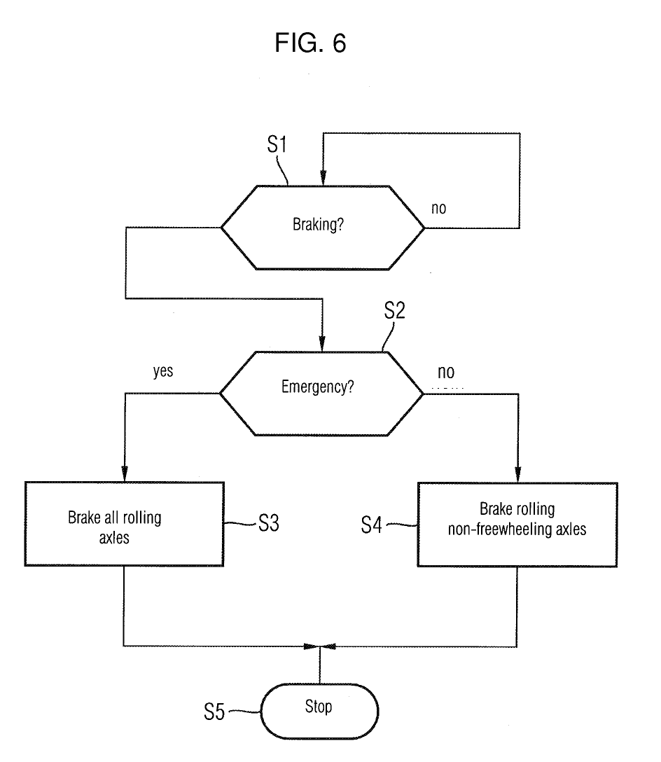

FIG. 6: shows a flowchart of a braking process for the braking system according to the invention;

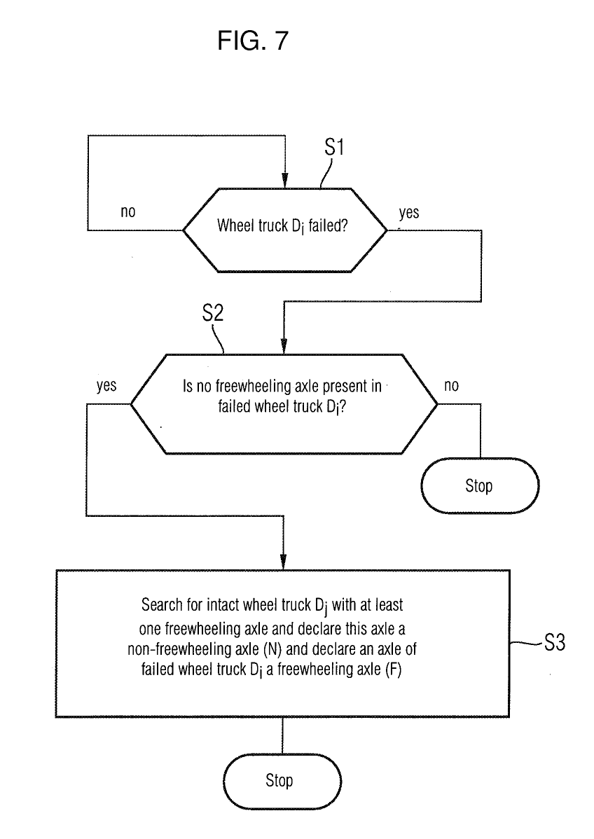

FIG. 7: shows a flowchart for explaining a preferred embodiment of the method according to the invention.

As shown in FIG. 3, the braking system according to the invention has a brake controller 1 which can be initialized, i.e. configured, via an interface 2 and contains at least one memory 3. The brake controller 1 is connected to a plurality of brakes 4A, 4B each mounted to a wheel 5A, 5B of a train axle 6. The brakes each have a line or more specifically a bus 7 which indicates the operating state or more specifically the status of the brake 4 to the brake controller 1. In addition, the brake controller 1 controls the brakes 4A, 4B via respective control lines 8A, 8B in order to apply the brakes. Optionally, sensors 9A, 9B which report the rolling state of the wheels to the brake controller 1 via lines 10A, 10B are additionally mounted to the wheels. In the system according to the invention, preferably all the axles 6 of the train are of completely identical design and each have brakes on their wheels. However, in the braking system according to the invention at least one axle of the train is activated, i.e. configured, as a freewheeling axle for determining the position of the train and the remaining axles are activated, i.e. configured, as non-freewheeling axles for braking the train. To configure an axle 6 as freewheeling, the associated brakes 4A, 4B provided thereon are de-activated and a counter (not shown) for counting the revolutions of said axles is activated. As soon as a brake 4A, 4B provided on an axle 6 configured as non-freewheeling fails, a hitherto freewheeling axle is activated by the brake controller 1 as a new non-freewheeling axle and the hitherto non-freewheeling axle whose brake has failed is activated by the brake controller 1 as a freewheeling axle for determining the position of the train Z.

FIGS. 4A, 4B show the memory contents of the memory 3 for a possible embodiment of the braking system according to the invention. In the example shown, the train has M axles, a majority of the axles 6 being initialized as non-freewheeling (N) and at least one of the axles 6 as freewheeling (F). In addition, the rolling state of the wheels 5 on the axles 6 is monitored via the sensors 9A, 9B. The brake controller 1 also monitors, via the brake status lines 7A, 7B, the operating state of the brakes 4A, 4B mounted to the axles 6. After initialization, i.e. configuration, if the brakes have been correctly installed, the brake status of all the brakes is initially ok. In the example shown in FIG. 4A, a brake 4 on the axle i configured as non-freewheeling fails after a certain operating time of the train Z (brake status=nok). In this situation a hitherto freewheeling axle provided for determining the position is reconfigured as a non-freewheeling axle by the brake controller 1 according to the invention. The axle with the failed brake, i.e. the axle i in the example shown in FIG. 4A, is activated by the brake controller 1 as a new freewheeling axle for determining the position of the train Z, as shown in FIG. 4B. The brake status of the reconfigured axle i continues to be defective (nok). In a possible embodiment of the method according to the invention, the axle j hitherto activated as freewheeling is only activated as non-freewheeling (N) by the brake controller 1 if it has previously been established that the brakes provided on the freewheeling axle j have not also failed. Emergency operation of the train Z is only initiated if the brake controller 1 establishes that no other freewheeling axle whose brakes have not failed is available.

FIG. 5 shows a possible embodiment of a process performed in the brake controller 1 for monitoring and reconfiguring axles of the train. As soon as the brake controller 1 ascertains, in a step S1, that a brake of a non-freewheeling (N) axle 6 has failed, the brake controller 1 checks, in a step S2, whether another freewheeling F axle 6 whose brakes 4A, 4B have not failed is available. If no other freewheeling axles whose brakes have not failed are available, the train goes into emergency mode in a step S3. In emergency mode S3, the brake failure is, for example, indicated to a control center and the speed of the train Z is reduced.

If the brake controller ascertains in step S2 that another freewheeling (F) axle 6 is available, in a step S4 one of the freewheeling (F) axles 6 present is declared a non-freewheeling (N) axle 6 by setting the corresponding flag.

In addition, in a step S5, the hitherto non-freewheeling (N) axle 6 with at least one failed brake 4A, 4B is now declared a freewheeling (F) axle 6 by setting the corresponding flag and activating the corresponding counter to count the revolutions of said axle.

FIG. 6 shows a flowchart illustrating a possible embodiment for executing a braking process in a braking system according to the invention.

If braking is initiated in a step S1, it is first checked in a step S2 whether it is an emergency situation. If it is an emergency situation, in step S3 all the rolling axles are braked, i.e. all the axles 6 are braked irrespective of their brake status and irrespective of whether they are configured as freewheeling or as non-freewheeling.

If it is not an emergency situation, in a step S4 only the rolling axles 6 declared non-freewheeling are braked.

Braking is terminated in step S5.

FIG. 7 shows another embodiment for reconfiguring the brakes in the braking system according to the invention.

In the embodiment shown in FIG. 7, it is taken into account that the braking axles are mounted to wheel trucks D of the train. First, in a step S1, it is monitored whether a brake of a non-freewheeling axle mounted to a first wheel truck Dᵢ has failed. If the brake of a non-freewheeling axle on the first wheel truck Dᵢ fails, in a step S2 it is checked whether no other freewheeling axle is available on the first wheel truck Dᵢ. If no other freewheeling axle is available on the first wheel truck Dᵢ, in a further step S3 another second wheel truck Dⱼ having at least one other freewheeling axle is searched for. If such a wheel truck is found, the freewheeling axle of said second wheel truck Dⱼ is reconfigured as a non-freewheeling axle and an axle of the failed first wheel truck Dᵢ is activated as a freewheeling axle for determining the position of the train.

In a possible embodiment of the method according to the invention, this is incorporated in an already present wheel slide protection mechanism of the train system. This wheel slide protection system detects whether a specific wheel of the train is sliding, i.e. locking at the time, so that braking of this wheel is ruled out or rather only takes place in a rolling state of the wheel. The wheel slide protection system is enhanced by the inventive method for activating a freewheeling axle in a braking force maintaining manner in that another logical “freewheeling axle” parameter is provided. If this new logical parameter is set to “No”, the wheel slide protection system fulfills its known intended functionality. However, if this new logical parameter is set to “Yes”, the corresponding brake is only activated in an emergency braking situation.

With the method according to the invention it is possible to reconfigure the axles even during operation of the train. In a possible embodiment this can also be done by a remote central controller via the interface 2 of the brake controller 1.

The braking system according to the invention offers a number of advantages. In train manufacture, all the axles can be treated in the same way, i.e. during design and assembly it is no longer necessary to differentiate between freewheeling axles and non-freewheeling axles.

A specific axle can be quickly, simply and reliably defined as the freewheeling axle at the end of the assembly process via the configuration of the brake controller 1 and the interface 2.

Another advantage is that emergency operation of a train is only initiated if, exceptionally, no other freewheeling axle whose brakes are not defective is present. This means longer train uptimes or rather less train downtime. It also indirectly enables the number of timetable disruptions to be reduced.

Another advantage of the braking system according to the invention is that the number of axles to be provided is minimized, as a freewheeling axle constitutes to some extent a standby for a failed non-freewheeling axle, thereby enabling the weight of the train to be likewise reduced.

1-13. (canceled)

14. A braking method for braking a train having a plurality of axles with brakes, the method which comprises:
activating at least one freewheeling axle for determining a position of the train and activating remaining axles as non-freewheeling axles to maintain a braking force for braking the train;
on occasion of a failure of a brake provided on a non-freewheeling axle, activating a previously freewheeling axle as a non-freewheeling axle and activating the non-freewheeling axle having the failed brake as a freewheeling axle for determining the position of the train.

15. The method according to claim 14, which comprises activating the axle hitherto activated as freewheeling as non-freewheeling only upon determining that the brakes provided on the previously freewheeling axle have not failed.

16. The method according to claim 14, which comprises, on determining that no freewheeling axle is available with brakes that have not failed, initiating emergency operation of the train.

17. The method according to claim 14, which comprises initializing the axles as non-freewheeling axles for braking the train and as freewheeling axles for determining the position of the train.

18. The method according to claim 14, which comprises, in a normal braking operation, braking the train by applying the brakes of the axles activated as non-freewheeling.

19. The method according to claim 14, which comprises, in an emergency braking operation, braking the train by applying the brakes of the axles activated as non-freewheeling and the brakes of the axles activated as freewheeling.

20. The method according to claim 14, which comprises, if a brake of a non-freewheeling axle mounted to a first wheel truck has failed and the first wheel truck has no freewheeling axle, searching for another second wheel truck having a freewheeling axle, the latter freewheeling axle being activated as a non-freewheeling axle and a non-freewheeling axle of the first wheel truck being activated as a freewheeling axle.

21. A braking system for a train having a plurality of axles, comprising:
a plurality of axles having brakes;
wherein at least one of said axles is activated as a freewheeling axle for determining a position of the train and remaining said axles are activated as non-freewheeling axles for braking the train; and
wherein, in the event of a failure of a brake provided on a non-freewheeling axle, a hitherto freewheeling axle is activated as a non-freewheeling axle and the non-freewheeling axle having the failed brake is activated as a freewheeling axle for determining the position of the train.

22. The braking system according to claim 21, wherein two wheels are mounted to each said axle, and each of said wheels has a brake for braking the train.

23. The braking system according to claim 22, which comprises a brake controller configured to control said brakes mounted to said axles through control lines.

24. The braking system according to claim 22, which comprises a brake controller and indication lines connected between said brakes mounted to said axles and said brake controller, and wherein said brakes indicate an operating state thereof to said brake controller via said indication lines.

25. The braking system according to claim 22, which comprises a sensor for detecting a rolling state of a wheel associated with each wheel.

26. The braking system according to claim 23, wherein said brake controller includes an interface via which each of said axles may be initialized as a non-freewheeling axle or as a freewheeling axle.
